(19) United States
(12) Patent Application Publication
(10) Pub. No.: US 2025/0193751 A1
(43) Pub. Date: Jun. 12, 2025

(54) USER EQUIPMENT PREDICTION FLOW IN TERRESTRIAL - NON-TERRESTRIAL NETWORK

(71) Applicant: Telefonaktiebolaget LM Ericsson (publ), Stockholm (SE)

(72) Inventors: Abdulrahman ALABBASI, Kista (SE); Konstantinos VANDIKAS, Solna (SE); Jonas SEDIN, Brentford (GB); Alessandro PREVITI, Stockholm (SE); Alexandros NIKOU, Danderyd (SE)

(21) Appl. No.: 18/843,205

(22) PCT Filed: Feb. 16, 2023
(86) PCT No.: PCT/EP2023/053877

§ 371 Date: Aug. 30, 2024

(30) Foreign Application Priority Data
Mar. 3, 2022 (GR) 20220100200

(51) Int. Cl. H04W 36/00; H04W 24/02

(52) U.S. Cl. CPC H04W 36/0085; H04W 24/02

(57) ABSTRACT

A method performed by a first network node for UE prediction flow in a terrestrial network (TN)-non-terrestrial network (NTN), TN-NTN network is provided. The method includes predicting a handover metric corresponding to respective categories of aggregated UEs for handovers between a source TN or NTN network node and a target NTN or TN network node, respectively. At least one of the respective categories of aggregated UEs includes UEs that fluctuate, based on a temporal threshold, between a connection to an NTN network node and a TN network node. The method further includes initiating at least one of (i) modification of a shape of a cell based on the predicted handover rate and volume, and (ii) allocation of UEs aggregated to the respective categories to different portions of a bandwidth.

### TECHNICAL FIELD

The present disclosure relates generally to a method for user equipment (UE) prediction flow in a terrestrial network (TN)-non-terrestrial network (NTN), TN-NTN system, and related methods and apparatuses.

### BACKGROUND

In Third Generation Partnership Project (3GPP), Release 15, 3GPP started work on preparing new radio (NR) for operation in a NTN. The work was performed within a study item “NR to support Non-Terrestrial Networks” and resulted in TR 38.811, Study on NR to support non-terrestrial networks. In 3GPP release 16, the work to prepare NR for operation in an NTN network continued with study item TR 38.821 “Solutions for NR to support Non-Terrestrial Network”. In parallel, interest to adapt narrowband Internet of Things (NB-IoT) and Long Term Evolution for Machines (LTE-M) for operation in a NTN appears to be growing. Consequently, 3GPP release 17 contains both a work item on NR NTN, RP-193234 Solutions for NR to support NTN, 3GPP RAN #86, and a study item on NB-IoT and LTE-M support for NTN, RP-193235 Study on NB-IoT/eMTC support for NTN, 3GPP RAN #86.

A satellite radio access network may include the following components: a satellite that refers to a space-borne platform; an earth-based gateway that connects the satellite to a base station or a core network, depending on the choice of architecture; a feeder link that refers to the link between a gateway and a satellite; and an access link that refers to the link between a satellite and a user equipment (UE).

Depending on the orbit altitude, a satellite may be categorized as low earth orbit (LEO), medium earth orbit (MEO), or geostationary earth orbit (GEO) satellite. A LEO satellite may have heights ranging from about 250-1,500 km, with orbital periods ranging from about 90-120 minutes. A MEO satellite may have heights ranging from about 5,000-25,000 km, with orbital periods ranging from about 3-15 hours. A GEO satellite may have a height of about 35,786 km, with an orbital period of about 24 hours.

A communication satellite may generate several beams over a given area. The footprint of a beam may be in an elliptic shape, which also may be considered as a cell. The footprint of a beam also may be referred to as a spotbeam. The footprint of a beam may move over the earth surface with the satellite movement or may be earth fixed with some beam pointing mechanism used by the satellite to compensate for its motion. The size of a spotbeam depends on the system design, which may range from, e.g., tens of kilometers to a few thousands of kilometers.

Architectures considered include the following: (1) a transparent payload (also referred to as bent pipe architecture). In this architecture, a network node (e.g., gNB) is located on the ground and the satellite forwards signals/data between the network node and the UE; and (2) a regenerative payload. In this architecture, the network node (e.g., gNB) is located in the satellite.

In the work item for NR NTN in 3GPP release 17, only the transparent architecture is considered.

FIG. 1 is a schematic diagram illustrating an example architecture of a satellite network with bent pipe transponders. The network node (e.g., gNB) may be integrated in the gateway or connected to the gateway via a terrestrial connection (e.g., wire, optic fiber, wireless link, etc.).

Propagation delay is an important aspect of satellite communications that is different from the delay expected in a terrestrial mobile system. For a bent pipe satellite network, the round-trip delay may, due to the orbit height, range from, e.g., tens of milliseconds (ms) in the case of LEO to several hundreds of ms for GEO. This can be compared to round-trip delays in a cellular network which may be limited to 1 ms.

The distance between the UE and a satellite can vary significantly, depending on the position of the satellite and thus the elevation angle & seen by the UE. Assuming circular orbits, the minimum distance is realized when the satellite is directly above the UE (ε=) 90°, and the maximum distance when the satellite is at the smallest possible elevation angle. Table 1 herein shows distances between a satellite and UE for different orbital heights and elevation angles together with the one-way propagation delay and the maximum propagation delay difference (the difference towards ε=) 90°. Note that Table 1 assumes a regenerative architecture. For a transparent architecture, the propagation delay between a gateway and satellite also needs to be considered, unless the base station corrects for that propagation delay.

TABLE 1
Propagation delay for different orbital heights and elevation angles

| | | | Distance | | One-way | | Propagation |
|---|---|---|---|---|---|---|---|
| Orbital | | Elevation | UE <−> | | propagation | | delay |
| height | | angle | satellite | | delay | | difference |
| 600 | km | 90° | 600 | km | 2.0 | ms | — |
| | | 30° | 1075 | km | 3.6 | ms | 1.6 ms |
| | | 10° | 1932 | km | 6.4 | ms | 4.4 ms |
| 1200 | km | 90° | 1200 | km | 4.0 | ms | — |
| | | 30° | 1999 | km | 6.7 | ms | 2.7 ms |
| | | 10° | 3131 | km | 10.4 | ms | 6.4 ms |
| 35786 | km | 90° | 35786 | km | 119.4 | ms | — |
| | | 30° | 38609 | km | 128.8 | ms | 9.4 ms |
| | | 10° | 40581 | km | 135.4 | ms | 16.0 ms |

The propagation delay also may be highly variable due to high velocity of LEO and MEO satellites and may change on the order of every 10-100 μs, depending on the orbit altitude and satellite velocity.

Mobility challenges in a NTN may include the following five challenges discussed in TR 38.821, Rel-16, Solutions for NR to support non-terrestrial networks.

Latency associated with mobility signaling. Without considering latencies such as radio resource control (RRC) processing delay and UE retuning its frequency circuits (which is smaller than the round trip time (RTT)), the interruption time would be 2 RTT (about 1080 ms) for downlink and 1.5 RTT (about 810 ms) for uplink. GEO scenarios are characterized by much larger propagation delay than LEO, however, the latter requires consideration of satellite movement. To avoid extended service interruption, latency associated with mobility signalling should be addressed with high priority in both cases. Solutions developed may apply to both scenarios.

Measurement Validity. Extending Rel-15 measurement-based mobility mechanisms to NTN may introduce the risk of outdated measurements given sufficient delay between transmission of the measurement report and reception of the handover (HO) command. The measurements may no longer be valid, possibly leading to an incorrect mobility action, e.g., early/late handover.

Cell overlap and reduced signal strength variation. To avoid an overall reduction in HO robustness due to the UE ping-ponging between cells, this challenge should be addressed with high priority for both GEO and LEO scenarios. Location information and/or satellite ephemeris would be useful in addition to measurement results, and solutions may apply to both scenarios. FIGS. 2A and 2B are schematic diagrams illustrating a near-far effect in different scenarios: FIG. 2A in a TN, and FIG. 2B in an NTN.

Frequent and unavoidable handover. The frequency of HO occasions for a single UE might vary from 6.49 to 132.28 seconds.

Handover for a large number of UEs, which may lead to large variations of load. An average hand-out rate UE per second may vary from 495 to 9912 UEs; and an average HO rate (in and out) of UEs per second may vary from 990 to 19824 UEs.

Some approaches discuss possible use of artificial intelligence (AI)/machine learning (ML) related to HOs. CN113498137A discusses a method and device for obtaining cell relation model and recommending cell switching guide parameters. CN111372255 discusses a method and system for neighbor relationship prediction based on graph convolutional neural network. Huihui Xu, et al. discusses QoE-Driven Intelligent Handover for User-Centric Mobile Satellite Networks in IEEE Transactions on Vehicular Technology, 2020.0608 IEEE, USA, vol. 69, no. 9, 10127-10139 (2020) (DOI), http://dx.doi.org/10.1109/TVT.2020.3000908,

### SUMMARY

There currently exist certain challenges. Predicting or anticipating a HO rate before it happens may be an essential part of achieving zero HO disconnectivity for UEs moving between TN and NTN network nodes (e.g., gNBs or satellites). Prediction may help a target network node (e.g., target NTN gNB) prepare needed resources accordingly (e.g., such as determining the shape of the cell). In an NTN system, HO events can occur for many UEs. For example, as previously referenced, an average HO rate (in and out) of UEs per second may vary from 990 to 19824 UEs. Problems may occur if a TN-NTN system (e.g., a gNB or satellite) attempts to predict such a number of HOs individually because individual prediction may introduce substantial computation complexity. Moreover, when UEs fluctuate between connecting to a satellite (e.g., NTN-gNB) and a terrestrial network node (e.g., TN-gNB) in a heterogeneous network, frequent HO may occur which also may cause frequent disconnectivity or high computation load. Additionally, when such higher oscillating UEs are in a TN-NTN network, further potential problems may include computation consumption, energy consumption (at the network and/or UE level), and/or discontinuous connection.

Certain aspects of the disclosure and their embodiments may provide solutions to these or other challenges.

In some embodiments, a method performed by a first network node for UE prediction flow in a TN-NTN network is provided. The method includes predicting a handover metric corresponding to respective categories of aggregated user equipment, UEs, for handovers between a source TN or NTN network node and a target NTN or TN network node, respectively. The at least one of the respective categories of aggregated UEs includes UEs that fluctuate, based on a temporal threshold, between a connection to an NTN network node and a TN network node. The method further includes initiating at least one of (i) modification of a shape of a cell of at least one of the source TN or NTN network node and the target NTN or TN network node, respectively, based on the predicted handover rate and volume, and (ii) allocation of UEs aggregated to the respective categories to different portions of a bandwidth.

In some embodiments, a first network node for a TN-NTN network is provided. The first network node includes processing circuitry; and memory coupled with the processing circuitry. The memory includes instructions that when executed by the processing circuitry causes the first network node to perform operations. The operations include predict a handover metric corresponding to respective categories of aggregated user equipment, UEs, for handovers between a source TN or NTN network node and a target NTN or TN network node, respectively. The at least one of the respective categories of aggregated UEs includes UEs that fluctuate, based on a temporal threshold, between a connection to an NTN network node and a TN network node. The operations further include initiating at least one of (i) modification of a shape of a cell of at least one of the source TN or NTN network node and the target NTN or TN network node, respectively, based on the predicted handover rate and volume, and (ii) allocation of UEs aggregated to the respective categories to different portions of a bandwidth.

In some embodiments, a first network node for a TN-NTN network is provided. The first network node is adapted to perform operations including prediction of a handover metric corresponding to respective categories of aggregated user equipment, UEs, for handovers between a source TN or NTN network node and a target NTN or TN network node, respectively. The at least one of the respective categories of aggregated UEs includes UEs that fluctuate, based on a temporal threshold, between a connection to an NTN network node and a TN network node. The operations further include initiation of at least one of (i) modification of a shape of a cell of at least one of the source TN or NTN network node and the target NTN or TN network node, respectively, based on the predicted handover rate and volume, and (ii) allocation of UEs aggregated to the respective categories to different portions of a bandwidth.

In some embodiments, a computer program is provided that includes program code to be executed by a processing circuitry of a first network node for a TN-NTN network. The operations including prediction of a handover metric corresponding to respective categories of aggregated user equipment, UEs, for handovers between a source TN or NTN network node and a target NTN or TN network node, respectively. The at least one of the respective categories of aggregated UEs includes UEs that fluctuate, based on a temporal threshold, between a connection to an NTN network node and a TN network node. The operations further include initiation of at least one of (i) modification of a shape of a cell of at least one of the source TN or NTN network node and the target NTN or TN network node, respectively, based on the predicted handover rate and volume, and (ii) allocation of UEs aggregated to the respective categories to different portions of a bandwidth.

In some embodiments, a computer program product including a non-transitory storage medium including program code to be executed by processing circuitry of a first network node is provided. Execution of the program code causes the first network node to perform operations. The operations including prediction of a handover metric corresponding to respective categories of aggregated user equipment, UEs, for handovers between a source TN or NTN network node and a target NTN or TN network node, respectively. The at least one of the respective categories of aggregated UEs includes UEs that fluctuate, based on a temporal threshold, between a connection to an NTN network node and a TN network node. The operations further include initiation of at least one of (i) modification of a shape of a cell of at least one of the source TN or NTN network node and the target NTN or TN network node, respectively, based on the predicted handover rate and volume, and (ii) allocation of UEs aggregated to the respective categories to different portions of a bandwidth.

In some embodiments, a TN-NTN system is provided. The TN-NTN system includes a first TN or NTN network node configured to predict a handover metric corresponding to respective categories of aggregated user equipment, UEs, for handovers between a source TN or NTN network node and a target NTN or TN network node, respectively. The at least one of the respective categories of aggregated UEs includes UEs that fluctuate, based on a temporal threshold, between a connection to an NTN network node and a TN network node. The TN-NTN system further includes at least one additional TN or NTN network node configured to initiate at least one of (i) modification of a shape of a cell of at least one of the source TN or NTN network node and the target NTN or TN network node, respectively, based on the predicted handover rate and volume, and (ii) allocation of UEs aggregated to the respective categories to different portions of a bandwidth.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example architecture of a satellite network with bent pipe transponders;

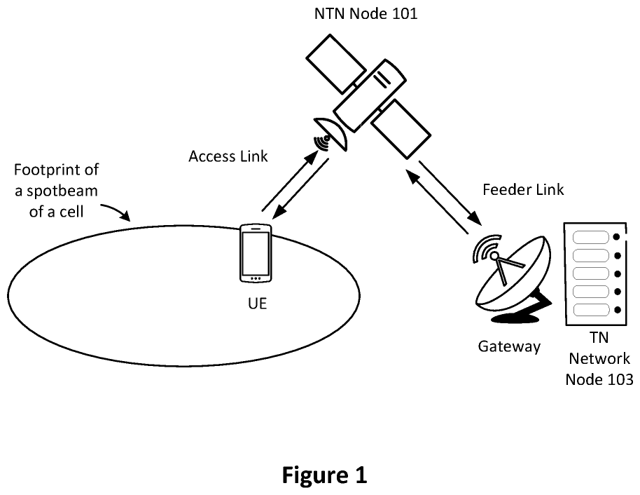

FIGS. 2A and 2B are schematic diagrams illustrating a near-far effect in different scenarios: FIG. 2A in a TN, and FIG. 2B in an NTN;

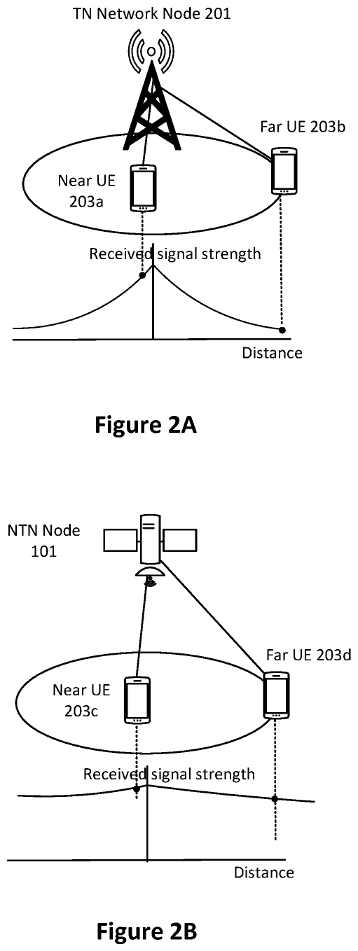

FIG. 3 is a block diagram illustrating a network in accordance with some embodiments of the present disclosure;

FIG. 4 is a flowchart illustrating operations of a network node in accordance with some embodiments of the present disclosure;

FIG. 5 is a signaling diagram illustrating an example embodiment in accordance with some embodiments of the present disclosure;

FIG. 6 is a block diagram of a first network node in accordance with some embodiments of the present disclosure;

FIG. 7 is a block diagram of a communication system in accordance with some embodiments of the present disclosure; and

FIG. 8 is a block diagram of a UE in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

The following explanation of potential problems with some approaches is a present realization as part of the present disclosure and is not to be construed as previously known by others.

As previously referenced, some approaches discuss possible use of artificial intelligence (AI)/machine learning (ML) related to HOs. See e.g., Cellular Network Traffic Prediction Incorporating Handover: A Graph Convolutional Approach, S. Zhao, et al., published in 2020 17th Annual IEEE International Conference on Sensing, Communication, and Networking (SECON); GCLR: GNN-Based Cross Layer Optimization for Multipath TCP by Routing, Artificial Intelligence for Satellite Communication: A Review, T. Zhu et al., DOI: 10.1109/ACCESS.2020.2966045 (2020).

Such approaches, however, may lack at least the following in a TN-NTN network: prediction of HOs between different cells; cell shaping for a planned HO; topological information of network nodes and different classes of aggregated UEs and their characteristics; classification/aggregation of UEs; use of a machine learning (ML) model that predicts categories of UE HOs volume and frequency; differentiation of treatment between different aggregated classes of UEs; and use of the output of the ML model to perform cell-shaping and bandwidth allocation that matches different categories of aggregated UEs.

Certain aspects of the disclosure and their embodiments may provide solutions to these or other challenges.

In some embodiments, a first network node in a heterogenous TN-NTN network predicts a dynamic flow of an aggregated number of UEs based on the categories of UEs; and initiates at least one of modification of a satellite cell shape (or in other words, a spotbeam), and allocation of each UE category to a corresponding bandwidth (e.g., physical resource block (PRB) that corresponds to its category, which may have low degradation impact on the network).

A heterogenous TN-NTN network refers to a network in which a UE can connect to two different types of network technologies (e.g., a TN 3GPP network and a NTN 3GPP network). For example, the UE can support dual connectivity (also referred to as DCNR) where the UE supports connection to both fourth generation long term evolution (4G-LTE) and fifth generation (5G) technology within the TN and/or the NTN, or the UE can HO between the TN and the NTN.

As used herein, the term “network node” refers to equipment capable, configured, arranged, and/or operable to communicate directly or indirectly with other network nodes, UEs, or equipment in a TN-NTN network. Examples of network nodes include, but are not limited to, base stations in the TN and/or in the NTN (e.g., g Node Bs (gNBs), evolved Node Bs (eNBs), core network nodes, access points (APs) (e.g., radio access points) etc.; and network nodes that provide operations, administration, and maintenance (OAM) for provisioning and managing a network or an element within a network (e.g., an OAM network node in a TN-NTN network).

Potential advantages provided by certain embodiments of the present disclosure may include that based on prediction of dynamic flow of different categories of aggregated UEs in a TN-NTN network, and allocating the different categories to a corresponding bandwidth, a reduction of a number of oscillating UEs may result. Additionally, as a consequence, energy consumption and links disconnections may be reduced, while computation cost may be kept low (e.g., at minimum). Additionally, based on inclusion of bandwidth divided into portions that correspond to categories of aggregated UEs, interference may be reduced.

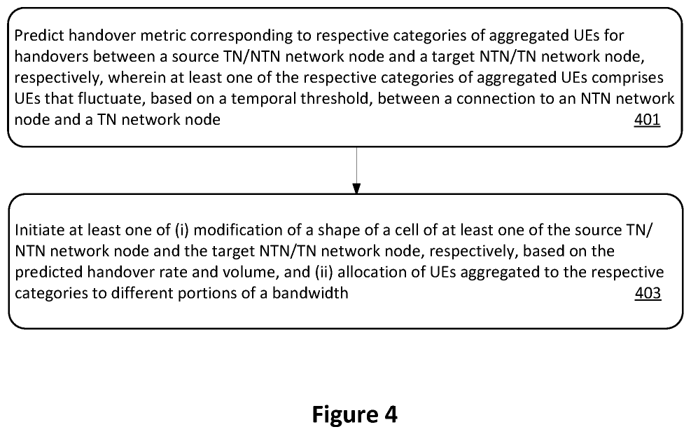

FIG. 4 is a flowchart illustrating a method performed by a first network node for UE prediction flow in a TN-NTN network. The method includes predicting (401) a handover metric corresponding to respective categories of aggregated user equipment, UEs, for handovers between a source TN or NTN network node and a target NTN or TN network node, respectively. The at least one of the respective categories of aggregated UEs includes UEs that fluctuate, based on a temporal threshold, between a connection to an NTN network node and a TN network node. The method further includes initiating (403) at least one of (i) modification of a shape of a cell of at least one of the source TN or NTN network node and the target NTN or TN network node, respectively, based on the predicted handover rate and volume, and (ii) allocation of UEs to the respective categories to different portions of a bandwidth.

The handover metric may include at least one of a handover rate and handover volume.

The temporal threshold may be included in a set of temporal thresholds. Aggregated UEs may be categorized based on the set of temporal thresholds. For example, UEs may be categorized based on their association (and impact of fluctuating) with a network node (e.g., a gNB). The categorization may include (i) a first category of aggregated UEs that stay attached to a cell of a serving network node for more than a first defined time period, (ii) a second category of aggregated UEs that handover to a target network node from a source network node within a second defined time period and do not reassociate with the source network node before a third defined time period, and (iii) a third category of aggregated UEs that handover to a target network node from the source network node within a fourth defined time period and reassociate to the source network node before a fifth defined time period.

In an example embodiment, a metric for categorizing the UEs may be a time of association to a network (e.g., to an NTN-gNB):
Core UEs (C-UEs): UEs that stay connected with the serving network node for more than tc-sec (e.g., association time>tc (e.g., tens of seconds))
Temporary UEs (T-UEs): UEs that HO to a target network node from a serving network node within te−sec, and do not reassociate to the original serving network node before te+tp seconds (e.g., association time<te and re-association time>te+tp). For example, temporary UEs may include UEs moving toward a target network node that cross a spotbeam.
Oscillating UEs (O-UEs): UEs that HO to a target network node from a serving network node within tp-see, and reassociate to the original serving network node before te+tp seconds (e.g., association time<tp and re-association time<te+tp). For example, oscillating UEs may include UEs that are stationary or moving slowly and HO frequently (e.g., every 10 ms, 100 ms, etc.). By HO frequently, such oscillating UEs may exhaust computation resources in the communication system.

While various embodiments are described with reference to the above three categories of UEs, the invention is not so limited, and includes breaking down the three categories into further categories using further times of association to the network.

In another example embodiment, a metric for categorizing the UEs may be an energy cost (or energy savings) of such an association (e.g., setup and/or data transfer energy cost or other sources of energy consumption costs).

Based on a metric for categorizing the UEs, a clustering/classification algorithm may be used to determine the category in which a UE belongs. Such a clustering or classification algorithm may be a simple rule-based algorithm as described above, or it may be a ML algorithm with input related to a network key performance indicator, KPI, that is relevant to clustering or classification.

Thus, core UEs may be well-behaved devices that are desirable to keep in the network; oscillating UEs may be UEs that cause issues as described herein; and temporary UEs may be UEs that may be controlled due to their real movement.

The predicted handover rate and volume may include one or more of (i) a volume of handovers at a next time period, (ii) a number of aggregated UEs in the respective category of aggregated UEs for the source TN or NTN network node and the target NTN or TN network node, respectively, and (iii) a fluctuation of the operating load at the next time period for the source TN or NTN network node and the target NTN or TN network node, respectively.

Referring again to FIG. 4, the predicting may be performed by a ML model. In some embodiments, a ML model is used to predict the flow dynamics of the UEs HO in/out and in-between NTN gNBs and TN gNBs.

The ML model may learn a function F(u, v)=I, wherein u and v are each an edge in a graph, and I is the volume of handovers. U and v may be expressed as vectors containing features of a cell. The features may include (i) a topology of the respective source TN or NTN network nodes and the respective target NTN or TN network nodes in the graph, (ii) an actual operating load of the respective source TN or NTN network nodes and the respective target NTN or TN network nodes in the graph, and (iii) a capacity range for the operating load of the respective source network nodes and the respective target network nodes in the graph.

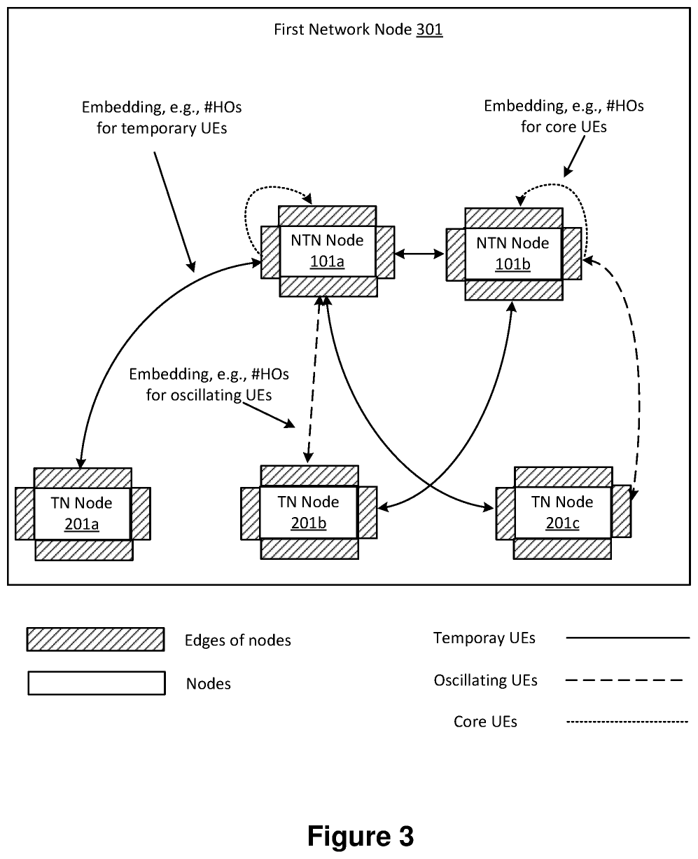

In some embodiments, the ML model is a graph neural network (GNN) model. FIG. 3 is a block diagram illustrating a GNN model of first network node 301 in accordance with some embodiments of the present disclosure. NTN network nodes 101a, 101b, etc. and TN network nodes 201a, 201b, etc. may be formulated as nodes in a graph, with information characteristics of those nodes and information exchanged among them represented as embedding and HO rates of the edges between them. Dotted lines illustrate embeddings for core UEs (e.g., number of HOs for core UEs); solid lines illustrate embeddings for temporary UEs (e.g., number of HOs for temporary UEs); and dashed lines illustrate embedding for oscillating UEs (e.g., number of HOs for oscillating UEs). As discussed further herein, FIG. 3 illustrates an overview of how a GNN can be used to predict a dynamic flow of HOs for core-UEs, temporary-UEs, and oscillating-UEs.

Inputs to the GNN for dynamic flow prediction may include an adjacency matrix including, without limitation:
(1) Topology of network nodes (e.g., NTN-gNBs and TN-gNBs) including, a location of the network nodes and/or a location of a cell. A graph (e.g., adjacency matrix) can show which can communicate with another cell;
   (2) Ground spotbeams topology can be included in the graph (e.g., adjacency matrix) as a bounding box (e.g., polygon) that illustrates an area that is covered by NTN beams. Ground spotbeams topology can further include (a) a number of spotbeams per targeted satellite; (b) a capacity of each/aggregated spotbeam; (c) neighbor network nodes (e.g., TN-gNBs) of each satellite spotbeam; and/or
   (3) Inter-satellite links (ISLs) connection topology as it may not be straight forward to control the satellite connection or mobility pattern. Thus, this type of topology may be dominant and pre-determined via the mobility pattern of the satellites. ISL links topology can show which NTN network node(s) connects with another NTN network node over an ISL, expressed as an adjacency model.

Additional inputs to the GNN for dynamic flow prediction may include an actual operating load of a target network node (e.g., NTN-gNB) and a neighbor network node (e.g., NTN-gNB); and a capability of a satellite (e.g., mean/min/max) of operating load.

Outputs of the GNN may include a prediction of a number of HOs in and out, which may be represented as one or more of: a volume of HO at a next x second; a number of categorical UEs and/or geographic information for the categorical UEs (e.g., core-UEs, temporary UEs, and oscillating UEs) per specific network node (e.g., NTN-gNB) and corresponding neighbour network nodes (e.g., gNBs); and/or load fluctuation at a next x second, (which may be represented via predicted spectral utilization per each category of UEs).

The initiating (403) at least one of modification and allocation may include signaling a TN or NTN network nodes that includes a reinforcement learning (RL) agent to process an input comprising the predicted handover rate and volume to decide the modification to the shape of the cell and the allocation of the portion of the bandwidth based on maximizing a reward value.

In some embodiments, the initiating (403) includes that the steps of predicting (401), modifying, and allocating can be performed at the same network node.

The reward value may include a weighted sum of a plurality of metrics. The plurality of metrics may include (i) a number of aggregated UEs, or a utilization of a number of aggregated UEs, per category of the plurality of categories of aggregated UEs, (ii) a cost of switching the portion of the bandwidth on a UE and on a TN or NTN network node, and (iii) a value for a key performance indicator, KPI.

In some embodiments, an input to the RL agent at a first network node includes the output of the ML model (e.g., the GNN). The RL agent may produce an action for at least one of the cell reshaping and allocation of aggregated UEs to a portion of a bandwidth (e.g., to an optimal portion of PRBs classes).

The input to the RL agent may further include (i) a location of individual UEs in a respective category of aggregated UEs from the plurality of categories of aggregated UEs, (iii) a statistical representation of a key performance indicator, KPI, (ii) whether a TN or NTN network node includes a capability to modify the shape of the cell, and (iii) a buffer status report, BSR, of individual UEs in a respective category of aggregated UEs.

In other words, the input to the RL agent may include one or more of the following states: (1) predicted HO volume and fluctuation; (2) location (which may include a geographic representation) of core-UEs, temporary UEs, and/or oscillating UEs; (3) selected parts of distribution of specific KPIs (e.g., statistical representations such as 10%, 50%, and 90% of the following distributions: a) latency, b) energy, c) SINR; or mean and variance of the following distributions: a) latency, b) energy, c) SINR, etc.); (4) a capability of a node to change a cell shape (e.g., a capability of a NTN-gNB to change a spot beam, e.g., degree of widening the spot beam which causes changes in a size of the spot beam on the ground); and/or (5) a buffer status report (BSR) of individual UEs. It is noted that the example KPI energy metric may be an energy consumption cost of a satellite to serve core-UEs, temporary-UEs, and oscillating-UEs. This energy may include approximate static and dynamic parts of energy of the satellite.

As discussed, the reward of the RL agent may include one or more of the following: (1) a weighted number of UEs (e.g., a weighted number of core UEs, temporary UEs and/or oscillating UEs). It is noted that a number of oscillating UEs may be expected to decrease as an effect of the action and, thus, the RL agent receives a positive reward value; (2) bandwidth switching cost (e.g., PRB switching cost in terms of computation, energy, interference, etc.) on both UEs and nodes (e.g., gNBs); (3) KPI based (e.g., high UE energy, association time to NTN, throughput, signal to interference noise ratio (SINR), reference signal received power (RSRP); energy and computation cost of handing over a UE from NTN to TN or NTN to TN, etc.).

Actions of the RL agent may include two types of actions, one related to cell shaping of the satellites and another related to network node (e.g., TN-gNB and/or NTN-gNB) resource allocation including, e.g.: (1) satellite cell shaping actions (e.g., adding/removing of beams within a cell, scaling up/down a spotbeam, shifting a beam(s) left, right, up, and/or down), etc.; and/or (2) resource allocation actions per network node (e.g., per NTN-gNB and/or TN-gNB).

Modification to the shape of the cell may include at least one of (i) adding or removing a beam within the cell, (ii) scaling a beam in the cell to increase or decrease in size, and (iii) shifting a beam in the cell in a lateral direction or in elevation direction.

Allocation of the respective categories of aggregated UEs to different portions of a bandwidth may include allocation of the respective categories of aggregated UEs to different portions of a bandwidth comprises dividing the bandwidth into the different portions of the bandwidth and allocating the respective categories of UEs to different portions respective portions of the bandwidth having different switching frequencies.

Based on resource allocation actions, a network node (e.g., NTN-gNB) may attempt to protect and increase core-UEs by guaranteeing a quality of service (QOS) via allocating core-UEs to a portion of a bandwidth (e.g., PRBs) that has a more stable radio environment and stable interference.

In an example embodiment, measures of classifying a bandwidth into different portions may include, without limitation, classifying the bandwidth (BW) (e.g., PRBs) into: (1) Core-node (e.g., gNB)-BW (also referred to herein as C-PRB). This portion of BW may be associated/matched to UEs that have less switching frequency and may need a more stable environment (e.g., their communication function (e.g., encoder/decoder) needs a predictable and stable amount of interference); (2) Shared neighbour-node (e.g., gNB)-BW (also referred to herein as SN-PRB). This portion of BW may be associated to UEs that have high switching frequency from a cell to neighbor cells, but they often come back quickly (e.g., such a portion of BW (e.g., a class of PRB) does not guarantee stable interference and, thus, communication function may not be sensitive to non-stable interference; and/or (3) Shared-node (e.g., gNB)-BW (also referred to herein as S-PRB). This portion of BW may be associated to UEs that have low association time with a cell, and they often do not re-associate to the same original cell (e.g., such a portion (e.g., a class of PRB) considers the QoS of the matched UE. Some QoS may be less sensitive to stability of interference than others which may be sensitive or more sensitive).

Based on classifying a bandwidth into different portions, an action of the RL agent may be to: (1) Find a split (e.g., an optimal split) between bandwidth (e.g., PRB) classes (e.g., C-PRB, SN-PRB, and/or S-PRB via utilizing the output of the ML agent); (2) Allocating core-UEs to a first portion of the bandwidth (e.g., to C-PRB), allocating temporary-UEs to a second portion of the bandwidth (e.g., to S-PRB), and/or allocating oscillating-UEs to a third portion of the bandwidth (e.g., to SN-PRB).

As previously referenced herein with respect to FIG. 3, in some embodiments the ML agent is a GNN. An input to the GNN includes a graph (also referred to herein as an adjacency matrix) where edges of network nodes are each weighted proportionally to a handover rate between each link. This may be represented in tabular form. An example embodiment of such a table representing an adjacency matrix is shown below:

| | target_NTN_gNB1 | target_NTN_gNB2 | . . . | | target_NTN_gNBn |
|---|---|---|---|---|---|
| source_NTN_gnb1 | 0 | 5000 | | | 8000 |
| source_NTN_gNB2 | 5000 (UE/s) | 0 | | | 6000 |
| . . . | | | 0 | | |
| . . . | | | | 0 | |
| source_NTN_gNBn | 3000 | 8000 | | | 0 |

The adjacency matrix may further include, at every node (e.g., NTN_gNB1, NTN_gNB2, through NTN_gNBn), additional features including, without limitation: (1) Topology of an NTN network node may be split in two aspects (i) Ground spotbeams topology and characteristics (e.g., number of spots beam per targeted satellite, capacity of each/aggregated spotbeam, neighbor gNBs (e.g., especially TN-gNBs) of each satellite spotbeam, etc.), and (ii) ISLs connection topology. Since it may not be straight forward to control the satellite connection or mobility pattern, this type of topology may be dominant and pre-determined via the mobility pattern of the satellites; (2) Actual operating Load of a target network node (e.g., NTN-gNB) and neighbour network node (e.g., NTN-gNB); and/or (3) a capability of a satellite (e.g., mean/minimum/maximum of operating load).

Output of a GNN dynamic prediction model may include a prediction(s) of a number of HOs (e.g., in and out). Without limitation, the prediction may be represented as one or more of the following (1) a volume of HO at a next x sec; (2) Load fluctuation at a next x sec (ping-pong); and/or (3) Number of categorical UEs (e.g., including geographic information) per specific NTN-gNB and corresponding neighbour (e.g., categories of UEs may include core-UEs, temporary UEs, and/or oscillating UEs).

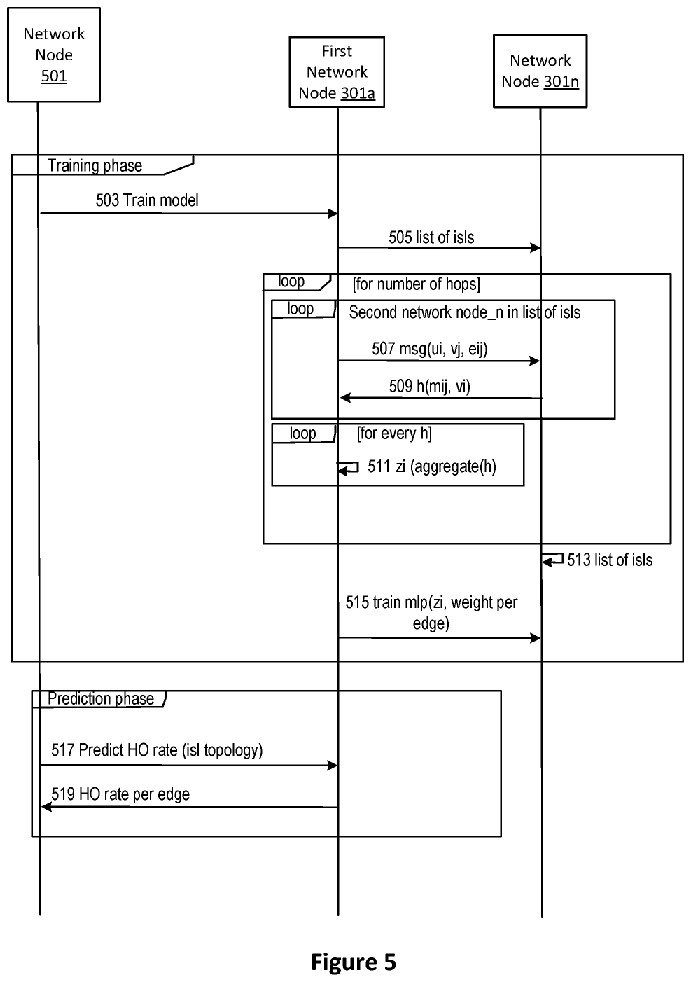

Given the input (e.g., the adjacency matrix), a GNN may be constructed. In an example embodiment, the GNN includes a GNN layer such as Graph Convolution Network (GCN), a GraphSage, or a graph attention network (GAT). The GNN may be tasked with learning a representation of each network node (e.g., TN-gNB and/or NTN-gNB) using the features of neighboring network nodes. A neighboring network node may be another network node that shares an ISL with a first network node. Thereafter, a multi-layer perceptron may be used to take the input from the GNN layer and, using that, learn a regression model which can be used to learn how to estimate HO rate using a supervised dataset. FIG. 5 is a signaling diagram illustrating an example embodiment of a TN-NTN system in accordance with some embodiments of the present disclosure. FIG. 5 includes first network node 301a (e.g., an NTN network node), a second network node 301n (e.g., another NTN network node) in a list of ISLs. Operations 503-515 are included in a training phase for a ML model (e.g., a GNN) to aggregate features of network nodes/UEs into a single network node. Operations 517-519 are included in a prediction phase using a RL agent to predict a handover rate corresponding to the aggregated UEs.

In operation 503 of the training phase, first network node 301a receives a message from network node 501 (e.g., an Operations, Administration and Maintenance (OAM) network node) to train a ML model. In operation 505, first network node 301a sends to second network node 301n a list of ISLs.

First network node 301a performs a loop of operations 507-509 (included in a first sub-loop) and operation 511 (included in a second sub-loop). The loop for operations 507-511 is performed for a number of hops included in ISLs between each set of first network node 301a and the respective network nodes in the list of ISLs. The first sub-loop of operations 507-509 are performed for each respective network node 301n in the list of ISLs. The second sub-loop of operation 511 is performed to aggregate the results from the first sub-loop, where a representation of two connected network nodes from the list of ISLs is identified by “h” in FIG. 5.

In operation 507, first network node 301a transmits a message to network node 301n requesting that network node 301n perform a calculation of vectors. Two vectors, ui and vj, represent the characteristics of each NTN network node. In addition, these vectors are neighbors meaning that in the adjacency matrix there is a link which connects the two (e.g., indicated either as 1 instead of 0 in row i and column j of the adjacency matrix or alternatively as the number of handovers between the two). Each vector includes characteristics/features of each NTN network node (e.g., the area that each NTN network node covers (in square meter), the number of spotbeams, the power each NTN network node consumes, etc.). This collection of network node characteristics/features can be referred to as node features. With a third vector, eij the features of the edge are represented. The vector eij can be, e.g., a 1 or 0; can be the number of handovers; or can be more complex (e.g., the number of handovers per hour). The collection of these vectors can be referred to as edge features). In operation 509, first network node 301a sends the result of the calculation to network node 301n containing h(mij, vi). mij is the aggregation of all linear transformations between adjacent vectors including node and edge features. In some embodiments, the node features of vector vi which initiated this call are also recursively included. Thus, two levels of aggregations are calculated, one between the u and v and another between all the neighbors of v which comes in the form of mij.

In operation 511, first network node 301a aggregates every h. The aggregation is represented in FIG. 5 by “zi”.

In operation 513, the list of ISLs is finished.

In operation 515, first network node 301a sends the trained ML model to network node 301n (trained on zi and a weight per edge of the network nodes connected via the ISLs (e.g., from an adjacency matrix input to a GNN being trained, where the weight per edge represents HOs that take place between network nodes in the list of ISLs)).

In the example embodiment of FIG. 5, in the prediction phase in operation 517, first network node 301a sends a message to network node 301n requesting a prediction of HO rates between a set(s) of network nodes (e.g., between an NTN-gNB and a TN-gNB). In operation 519, first network node 301a sends the predicted handover rate per edge to network node 301n.

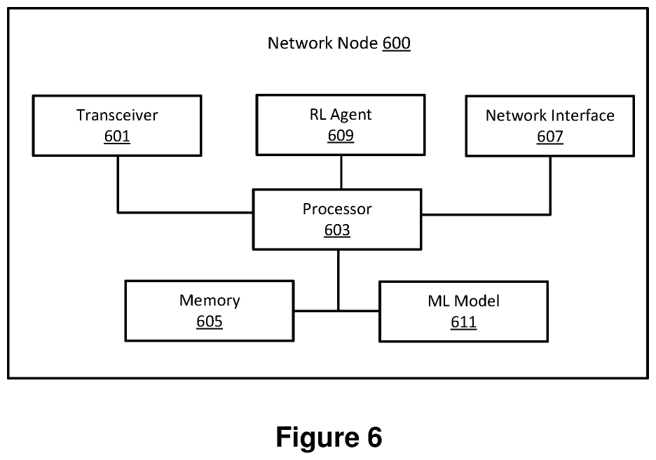

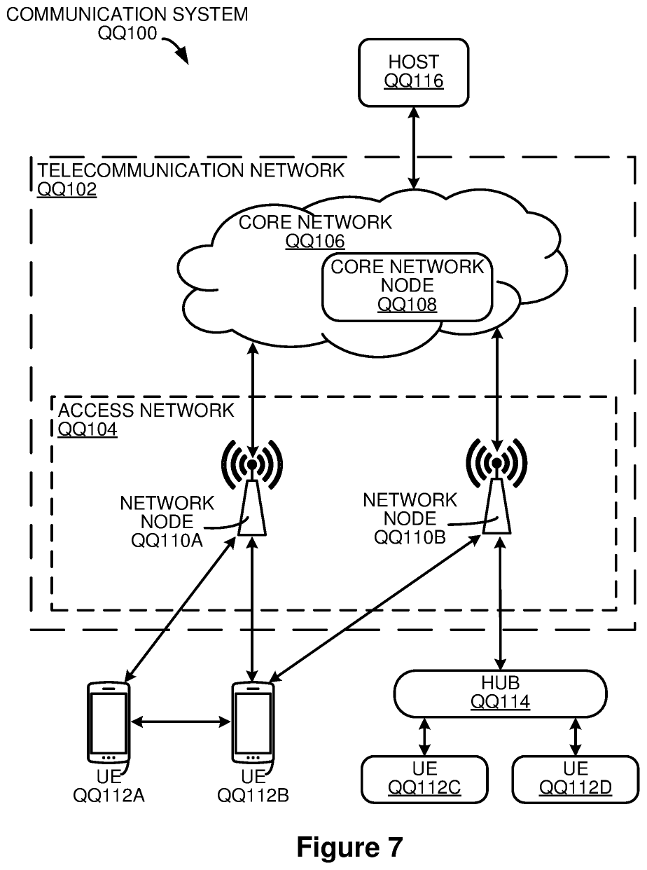

FIG. 6 is a block diagram illustrating elements of a first network node 600 configured with a ML model 611 (e.g., GNN) for predicting HO volume and frequency for categories of aggregated UEs and RL agent 609 for cell re-shaping and bandwidth matching/association with the different categories of aggregated UEs. Network node 600 may be provided by, e.g., a n NTN-network node or a TN-network node (e.g., such as gNBs) in a TN-NTN network. That is, the network node 600 may be implemented as part of a communications system (e.g., a network node that is part of the communications system QQ100 as discussed below with respect to FIG. 7).

While various embodiments are described with reference to a first network node that includes a ML model for predicting HO volume and frequency for categories of aggregated UEs and a RL agent for cell re-shaping and bandwidth matching/association with the different categories of aggregated UEs, the invention is not so limited. Rather, the first network node may include the ML model 611 and another network node(s) may be configured as shown in FIG. 6 with the RL agent 609 but without the ML model 611. That is, in some embodiments the first network node is configured with a ML model 611 (e.g., GNN) for predicting HO volume and frequency for categories of aggregated UEs; and at least one more network node is configured with the RL agent 609 for cell re-shaping and bandwidth matching/association with the different categories of aggregated UEs. For example, a second network node may be configured with the RL agent 609 for cell re-shaping, and a third network node may be configured with the RL agent 609 for bandwidth matching/association with the different categories of aggregated UEs.

As shown, the first network node may include transceiver circuitry 601 (e.g., RF transceiver circuitry) including a transmitter and a receiver configured to provide uplink and downlink radio communications with other network nodes and/or UEs. The first network node may include network interface circuitry 607 (also referred to as a network interface,) configured to provide communications with other network nodes and/or UEs. The first network node may also include processing circuitry 603 (also referred to as a processor) coupled to the transceiver circuitry, memory circuitry 605 (also referred to as memory) coupled to the processing circuitry, and RL agent 609 and ML model 611 coupled to the processing circuit. The RL agent 609, ML model 611, and/or memory circuitry 605 may include computer readable program code that when executed by the processing circuitry 603 causes the processing circuitry to perform operations according to embodiments disclosed herein. According to other embodiments, processing circuitry 603 may be defined to include memory, RL agent 609, or ML model 611 so that a separate memory circuitry or separate RL agent or ML model is not required.

As discussed herein, operations of the first network node may be performed by processing circuitry 603, network interface 607, and/or transceiver 601. For example, processing circuitry 603 may control RL agent 609 or ML model 611 to perform operations according to embodiments disclosed herein. Processing circuitry 603 also may control transceiver 601 to transmit downlink communications through transceiver 601 over a radio interface to one or more network nodes or UEs and/or to receive uplink communications through transceiver 601 from one or more devices over a radio interface. Similarly, processing circuitry 603 may control network interface 607 to transmit communications through network interface 607 to one or more network nodes or UEs and/or to receive communications through network interface from one or more network nodes or UEs. Moreover, modules may be stored in memory 605, and these modules may provide instructions so that when instructions of a module are executed by processing circuitry 603, processing circuitry 603 performs respective operations (e.g., operations discussed below with respect to example embodiments relating to network nodes). According to some embodiments, first network node 600 and/or an element(s)/function(s) thereof may be embodied as a virtual device/devices and/or a virtual machine/machines.

According to some other embodiments, a first network node may be implemented without a transceiver. In such embodiments, transmission to a wireless device may be initiated by the first network node 600 so that transmission to the wireless device is provided through a device including a transceiver (e.g., through a base station). According to embodiments where the first network node includes a transceiver, initiating transmission may include transmitting through the transceiver.

FIG. 7 shows an example of a communication system QQ100 in accordance with some embodiments.

In the example, the communication system QQ100 includes a telecommunication network QQ102 that includes an access network QQ104, such as a RAN, a core network QQ106, which includes one or more core network nodes QQ108, and an NTN network (not illustrated) as discussed herein. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The NTN network includes one or more network nodes, such as first network node 600. The network nodes QQ110, 600 facilitate direct or indirect connection of a user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 7 enables connectivity between the UEs, network nodes, hosts, and devices. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b).

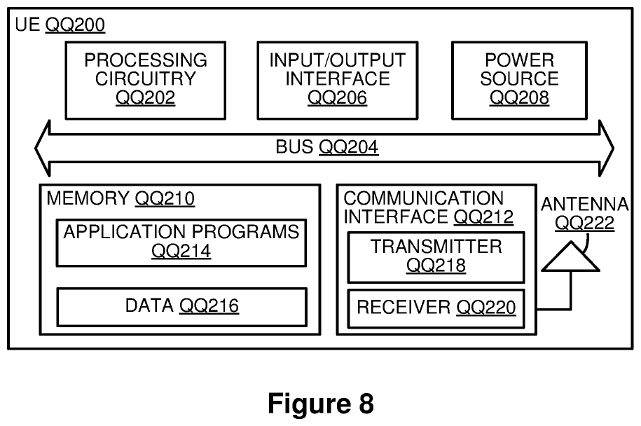

FIG. 8 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in Figure QQ2. The level of integration between the components may vary from one UE to another UE. Further, certain UEs may contain multiple instances of a component, such as multiple processors, memories, transceivers, transmitters, receivers, etc.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The processing circuitry QQ202 may be configured to communicate with an access network or other network (e.g., with a TN or an NTN) using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Although the devices described herein may include the illustrated combination of hardware components, other embodiments may comprise computing devices with different combinations of components. It is to be understood that these devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the device, and/or performing one or more operations based on the obtained information or converted information, and as a result of said processing making a determination. Moreover, while components are depicted as single boxes located within a larger box, or nested within multiple boxes, in practice, devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be an RL agent and/or computer program product (e.g., including an RL agent) in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the device, but are enjoyed by the device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a first network node for UE prediction flow in a terrestrial network (TN)-non-terrestrial network (NTN), TN-NTN network, the method comprising:
predicting a handover metric corresponding to respective categories of aggregated user equipment, UEs, for handovers between a source TN or NTN network node and a target NTN or TN network node, respectively, wherein at least one of the respective categories of aggregated UEs comprises UEs that fluctuate, based on a temporal threshold, between a connection to an NTN network node and a TN network node; and
initiating at least one of (i) modification of a shape of a cell of at least one of the source TN or NTN network node and the target NTN or TN network node, respectively, based on the predicted handover rate and volume, and (ii) allocation of UEs aggregated to the respective categories to different portions of a bandwidth.

2. The method of claim 1, wherein the handover metric comprises at least one of a handover rate and a handover volume.

3. The method of claim 1, wherein the temporal threshold is included in a set of temporal thresholds and the aggregated UEs are categorized based on the set of temporal thresholds.

4. The method of claim 3, wherein the categorization comprises (i) a first category of aggregated UEs that stay attached to a cell of a serving network node for more than a first defined time period, (ii) a second category of aggregated UEs that handover to a target network node from a source network node within a second defined time period and do not reassociate with the source network node before a third defined time period, and (iii) a third category of aggregated UEs that handover to a target network node from the source network node within a fourth defined time period and reassociate to the source network node before a fifth defined time period.

5. The method of claim 1, wherein the predicting is performed by a machine learning, ML, model.

6. The method of claim 5, wherein the ML model learns a function F(u, v)=I, wherein u and v are each an edge in a graph and I is the volume of handovers.

7. The method of claim 6, wherein u and v are expressed as vectors containing features of a cell, the features comprising (i) a topology of the respective source TN or NTN network nodes and the respective target NTN or TN network nodes in the graph, (ii) an actual operating load of the respective source TN or NTN network nodes and the respective target NTN or TN network nodes in the graph, and (iii) a capacity range for the operating load of the respective source network nodes and the respective target network nodes in the graph.

8. The method of claim 1, wherein the predicted handover rate and volume comprises one or more of (i) a volume of handovers at a next time period, (ii) a number of aggregated UEs in the respective category of aggregated UEs for the source TN or NTN network node and the target NTN or TN network node, respectively, and (iii) a fluctuation of the operating load at the next time period for the source TN or NTN network node and the target NTN or TN network node, respectively.

9. The method of claim 1, wherein the initiating at least one of modification and allocation comprises signaling a TN or NTN network nodes that comprises reinforcement learning, RL, agent to process an input comprising the predicted handover rate and volume to decide at least one of the modification to the shape of the cell and the allocation of the portion of the bandwidth based on maximizing a reward value.

10. The method of claim 9, wherein the reward value comprises a weighted sum of a plurality of metrics, the plurality of metrics comprising (i) a number of aggregated UEs, or a utilization of a number of aggregated UEs, per category of the plurality of categories of aggregated UEs, (ii) a cost of switching the portion of the bandwidth on a UE and on a TN or NTN network node, and (iii) a value for a key performance indicator, KPI.

11. The method of claim 9, wherein the input to the RL agent further comprises (i) a location of individual UEs in a respective category of aggregated UEs from the plurality of categories of aggregated UEs, (iii) a statistical representation of a key performance indicator, KPI, (ii) whether a TN or NTN network node includes a capability to modify the shape of the cell, and (iii) a buffer status report, BSR, of individual UEs in a respective category of aggregated UEs.

12. The method of claim 1, wherein the modification to the shape of the cell comprises at least one of (i) adding or removing a beam within the cell, (ii) scaling a beam in the cell to increase or decrease in size, and (iii) shifting a beam in the cell in a lateral direction or in elevation direction.

13. The method of claim 4, wherein the initiating allocation comprises signaling one of the TN or NTN network nodes, and the allocations comprises allocating the respective categories of aggregated UEs to different portions of a bandwidth comprises dividing the bandwidth into the different portions of the bandwidth and allocating the respective categories of UEs to different portions respective portions of the bandwidth having different switching frequencies.

14. A first network node for a terrestrial network (TN)-non-terrestrial network (NTN), TN-NTN network, the first network node comprising:
processing circuitry;
memory coupled with the processing circuitry, wherein the memory includes instructions that when executed by the processing circuitry causes the first network node to perform operations comprising:
prediction of a handover metric corresponding to respective categories of aggregated user equipment, UEs, for handovers between a source TN or NTN network node and a target NTN or TN network node, respectively, wherein at least one of the respective categories of aggregated UEs comprises UEs that fluctuate, based on a temporal threshold, between a connection to an NTN network node and a TN network node; and
initiation of at least one of (i) modification of a shape of a cell of at least one of the source TN or NTN network node and the target NTN or TN network node, respectively, based on the predicted handover rate and volume, and (ii) allocation of UEs aggregated to the respective categories to different portions of a bandwidth.

15. The first network node of claim 14, the operations further comprising operations of,
predicting a handover metric corresponding to respective categories of aggregated user equipment, UEs, for handovers between a source TN or NTN network node and a target NTN or TN network node, respectively, wherein at least one of the respective categories of aggregated UEs comprises UEs that fluctuate, based on a temporal threshold, between a connection to an NTN network node and a TN network node; and
initiating at least one of (i) modification of a shape of a cell of at least one of the source TN or NTN network node and the target NTN or TN network node, respectively, based on the predicted handover rate and volume, and (ii) allocation of UEs aggregated to the respective categories to different portions of a bandwidth,
wherein the handover metric comprises at least one of a handover rate and a handover volume.

16. A first network node for a terrestrial network (TN)-non-terrestrial network (NTN), TN-NTN network, the first network node adapted to perform operations comprising:
prediction of a handover metric corresponding to respective categories of aggregated user equipment, UEs, for handovers between a source TN or NTN network node and a target NTN or TN network node, respectively, wherein at least one of the respective categories of aggregated UEs comprises UEs that fluctuate, based on a temporal threshold, between a connection to an NTN network node and a TN network node; and;
initiation at least one of (i) modification of a shape of a cell of at least one of the source TN or NTN network node and the target NTN or TN network node based on the predicted handover rate and volume, and (ii) allocation of UEs aggregated to the respective categories to different portions of a bandwidth.

17.-21. (canceled)

22. A terrestrial network (TN)-non-terrestrial network (NTN), TN-NTN, system comprising:
a first TN or NTN network node configured to predict a handover metric corresponding to respective categories of aggregated user equipment, UEs, for handovers between a source TN or NTN network node and a target NTN or TN network node, respectively, wherein at least one of the respective categories of aggregated UEs comprises UEs that fluctuate, based on a temporal threshold, between a connection to an NTN network node and a TN network node; and
at least one additional TN or NTN network node configured to initiate at least one of (i) modification of a shape of a cell of at least one of the source TN or NTN network node and the target NTN or TN network node, respectively, based on the predicted handover rate and volume, and (ii) allocation of UEs aggregated to the respective categories to different portions of a bandwidth.
